(19) United States
(12) Patent Application Publication
(10) Pub. No.: US 2024/0306658 A1
(43) Pub. Date: Sep. 19, 2024

(54) CHOCOLATE AND SIMILAR PRODUCTS, SWEETENED AND FLAVORED WITH FREEZE-DRIED FRUITS

(71) Applicant: Halloren Schokoladenfabrik AG, Halle/Saale (DE)

(72) Inventor: Darren EHLERT, Nordkirchen (DE)

(73) Assignee: Halloren Schokoladenfabrik AG, Halle/Saale (DE)

(21) Appl. No.: 18/332,103

(22) Filed: Jun. 9, 2023

(30) Foreign Application Priority Data
Mar. 13, 2023 (EP) 23020123.8

(51) Int. Cl. A23G 1/48

(52) U.S. Cl. CPC A23G 1/48

(57) ABSTRACT

The invention relates to products such as chocolate, chocolate confections, pralines, etc. without refined sugar, wherein, besides from date powder, predominantly freeze-dried bananas, pineapple, and apples, with higher total sugar (sucrose, glucose and fructose), higher proportions of dietary fiber and vitamins, and simultaneously a comparatively lower proportion of carbohydrates, are added to the unsweetened chocolate and the cocoa butter as sweetener and for flavoring.

### CROSS-REFERENCE TO RELATED APPLICATIONS

The present application claims priority to European patent application number EP 23 020 123.8, which was filed on Mar. 13, 2023. The entire contents of EP 23 020 123.8 are hereby incorporated by reference herein.

### FIELD OF THE INVENTION

The invention relates to products such as chocolate, chocolate confections, pralines, and the production thereof, wherein, instead of refined sugar, freeze-dried fruit is used partially or completely as the sweetening agent and for flavoring.

### BACKGROUND OF THE INVENTION

Generally known in the prior art is that chocolate contains more- or less-refined sugars depending on the type.

EP 3648616, in contrast thereto, describes an invention which, instead of the traditional crystal sugar, provides for sweetening chocolate with dried sugar beets.

Dried honey powder instead of refined sugar is proposed in EP 3504980 as the sweetening component of chocolate.

Finally, the replacement of refined sugar or other sweeteners is known in the field of chocolate production by the exclusive use of finely ground dates (https://www.makri-schokolade.de).

Based on the task of developing chocolate products with novel taste profiles, the invention in DE 2020 07010107 relates to chocolate with the addition of green tea.

The invention in DE 2020 07010106 describes chocolate with the taste profile of carrot and sea buckthorn.

Finally, the invention in DE 2020 07010105 describes a chocolate with the taste profile of rosemary and lemon.

### BRIEF SUMMARY OF THE INVENTION

The present invention relates to the method for sweetening unsweetened chocolate by the addition of finely ground, freeze-dried bananas, pineapples, and apples. The additional inclusion of sugar or artificial sweeteners can thus be dispensed with.

### DETAILED DESCRIPTION OF INVENTION

Refined sugar is also traditionally added, with the exception of those items mentioned above, in the production of chocolate for bars, hollow confections, miniature chocolate bars, or as a coating for unsweetened cocoa constituents. The sugar content in such cases is up to 50% of the finished chocolate mass.

The usual components of a commercial chocolate are unsweetened chocolate, sugar, cocoa powder, cocoa butter, and lecithin. Milk or milk powder is additionally added for milk chocolate.

The present invention, on the other hand, relates to the production of chocolate to which, in the manufacturing process, instead of refined sugar or artificial sweeteners, apart from date powder, predominantly freeze-dried bananas, pineapple and apples are added for sweetening.

The addition according to the invention of the named fruits bananas, pineapple, and apple can preferably be made in combination, but also individually.

The fructose contained in the freeze-dried fruit bananas, pineapple, and apple as simple sugars is much sweeter than the glucose content in refined sugar. The amount used for the sweetening of the chocolate can thus be significantly reduced. This reduction seizes on the trend of eating healthily and with awareness of sugar.

Furthermore, the use of different, freeze-dried fruits or mixtures can also open up new and unique taste experiences. Thus, if necessary, no further addition of natural or artificial fruity flavors is necessary.

During freeze-drying, the taste of the freeze-dried fruit is largely maintained. This offers, in the final chocolate production, the unique possibility of influencing the taste of the end product with great variably. Depending on the fruit types used, taste variants can thus be added to the chocolate which allow for highly diverse fruit nuances. The same naturally also applies to finely tuned fruit mixtures. In addition, the taste intensity of the respective fruit notes can also be selectively adapted in order to give the end product the desired character. Furthermore, it is also possible with special fruits or fruit mixtures to add only the corresponding sweetness without changing the taste structure of the chocolate. In this case, the chocolate remains largely neutral in relation to the fruits added.

A further, nutritional advantage of the invention is that the freeze-drying, in contrast to the use of conventionally dried ingredients or the addition of crystal sugar, gives the valuable constituents of fruit, such as vitamins, for example.

In contrast to the use of conventionally dried ingredients or the addition of sugar, the nutritional value of freeze-dried fruit is lower. Depending on the fruit used and the proportions thereof, it can be up to 10% less than the nutritional value of conventional beet sugar. This is primarily due to the significantly lower proportion of carbohydrates in freeze-dried fruits.

A further nutritional advantage of the invention compared to the use of conventionally dried ingredients or the addition of sugar is the higher dietary fiber content of the freeze-dried fruits bananas, pineapple, and apple. Fiber can counteract weight gain, because it provides a long-lasting feeling of satiety.

The following table shows the nutritional value information of the freeze-dried fruit used according to the invention compared to conventional sugar:

| | | | Freeze-dried | | Freeze-dried | | Freeze-dried | |
|---|---|---|---|---|---|---|---|---|
| | | | Apple | | Pineapple | | Banana | |
| | Sugar | | powder | | powder | | powder | |
| Energy value, | 402 | kcal | 395 | kcal | 376 | kcal | 377 | kcal |
| kcal | | | | | | | | |
| Energy value | 1,683 | kj | 1,652 | kj | 1,591 | kj | 1,576 | kj |
| Fat | 0.0 | g | 0.8 | g | 0.85 | g | 1.2 | g |
| Saturated fat | 0.0 | g | 0.0 | g | 0.06 | g | 0.4 | g |
| Carbohydrates | 99.0 | g | 88.5 | g | 83.21 | g | 80.08 | g |
| Sugar | 99.0 | g | 77.7 | g | 69.94 | g | 48.8 | g |
| Dietary fiber | 0.0 | g | 10.0 | g | 9.94 | g | 10.4 | g |
| Protein | 0.0 | g | 2.3 | g | 3.83 | g | 4.4 | g |
| Salt | 0.0 | g | 0.01 | g | 0.02 | g | 0.0 | g |

The chocolate according to the invention is composed in detail of unsweetened cocoa mass, cocoa butter, date powder, and freeze-dried powder of bananas, pineapple and apples.

In some embodiments, the invention is a sweetened product containing, based on the total weight of the product:
52.55 wt %-64.23 wt % unsweetened chocolate (e.g., 52.55, 53, 53.5, 54, 54.5, 55, 55.5, 56, 56.5, 57, 57.5, 58, 58.5, 59, 59.5, 60, 60.5, 61, 61.5, 62, 62.5, 63, 63.5, 64, or 64.23 wt %), including any and all ranges and subranges therein;
19.71 wt %-24.09 wt % cocoa butter (e.g., 19.71, 19.8, 19.9, 20.0, 20.1, 20.2, 20.3, 20.4, 20.5, 20.6, 20.7, 20.8, 20.9, 21.0, 21.1, 21.2, 21.3, 21.4, 21.5, 21.6, 21.7, 21.8, 21.9, 22.0, 22.1, 22.2, 22.3, 22.4, 22.5, 22.6, 22.7, 22.8, 22.9, 23.0, 23.1, 23.2, 23.3, 23.4, 23.5, 23.6, 23.7, 23.8, 23.9, 24.0 or 24.09 wt %), including any and all ranges and subranges therein;
7.88 wt %-9.64 wt % date powder (e.g., 7.88, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, or 9.64 wt %), including any and all ranges and subranges therein; and
9.85 wt %-12.04 wt % of a combination of powder of freeze-dried bananas, powder of freeze-dried pineapple, and powder of freeze-dried apples (e.g., 9.85, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, or 12.04 wt %), including any and all ranges and subranges therein. For example, in some embodiments, the product contains 3.28 wt %-4.01 wt % (e.g., 3.28, 3.3, 3.4, 3.5, 3.6, 3.7, 3.8, 3.9, 4.0, or 4.01 wt %) of each of powder of freeze-dried bananas, powder of freeze-dried pineapple, and powder of freeze-dried apples, where the three powders may be present in the same amounts as, or different amounts from one another.

In the following, the proportional composition of the chocolate according to the invention is shown in a specific embodiment;

| | | |
|---|---|---|
| Unsweetened | 400.00 | grams |
| chocolate | | |
| Cocoa butter | 150.00 | grams |
| Date powder | 60.00 | grams |
| Powder of freeze-dried | 25.00 | grams |
| bananas | | |
| Powder of freeze-dried | 25.00 | grams |
| pineapple | | |
| Powder of freeze-dried | 25.00 | grams |
| apples | | |

Thus, the invention comprises about 80% cocoa mass and about 20% freeze-dried fruit. Aside from novel uses or other taste profiles, the proportions and/or the type of fruits mentioned can vary, be combined, or can be used individually.

The basic method steps for producing the chocolate according to the invention are as follows: The freeze-dried fruits are ground, together with the unsweetened cocoa material and the cocoa butter, by means of a ball mill or a stone mill. The grinding is carried out until the individual particles of the masses are so fine that they are no longer perceived as particles in the mouth. The ground mass is subsequently passed once again through a fine sieve in order to ensure that no more perceptible particles are present in the mass.

After this process, the finished chocolate is accordingly tempered for direct further processing, or for storage.

In summary, the method scheme is as follows:

Raw materials->grinding in ball mill or stone mill

### Sieve

### Tempering

Use/storage of the liquid chocolate

### Processing/Distribution

1. A sweetened product without refined sugar, characterized in that, instead of crystal sugar, and besides date powder, the product predominantly comprises powder of freeze-dried bananas, freeze-dried pineapple, and freeze-dried apples for sweetening and flavoring.

2. The sweetened product according to claim 1, wherein the product is chocolate, a chocolate confection, or praline.

3. The sweetened product according to claim 1, characterized in that the product is chocolate and comprises, in its proportional composition, 58.39% by weight of unsweetened chocolate, 21.90% by weight of cocoa butter, 8.76% by weight of date powder, 3.65% by weight of freeze-dried banana powder, 3.65% by weight of freeze-dried pineapple powder, and 3.65% by weight of freeze-dried apple powder.

4. The sweetened product according to claim 1, characterized in that the product is chocolate and comprises, in its proportional composition, 58.39% by weight of unsweetened chocolate, 21.90% by weight of cocoa butter, 8.76% by weight of date powder and 10.95% by weight of either freeze-dried banana powder, freeze-dried pineapple powder, or freeze-dried apple powder.

5. The sweetened product according to claim 1, characterized in that the product is chocolate and comprises, in its proportional composition, 58.39% by weight of unsweetened chocolate, 21.90% by weight of cocoa butter, 8.76% by weight of date powder and a total of, in unequal ratios of the three fruits with respect to one another, a total of 10.95% by weight of freeze-dried banana powder, freeze-dried pineapple powder, and freeze-dried apple powder.

6. The sweetened product according to claim 1, characterized in that the product is chocolate selected from white chocolate, milk chocolate or dark chocolate.

7. The sweetened product according to claim 1, comprising, based on the total weight of the sweetened product:
52.55 wt %-64.23 wt % unsweetened chocolate;
19.71 wt %-24.09 wt % cocoa butter;
7.88 wt %-9.64 wt % date powder; and
9.85 wt %-12.04 wt % of a combination of powder of freeze-dried bananas, powder of freeze-dried pineapple, and powder of freeze-dried apples.

8. The sweetened product according to claim 1, comprising, based on the total weight of the sweetened product:
52.55 wt %-64.23 wt % unsweetened chocolate;
19.71 wt %-24.09 wt % cocoa butter;
7.88 wt %-9.64 wt % date powder;
3.28 wt %-4.01 wt % powder of freeze-dried bananas;
3.28 wt %-4.01 wt % powder of freeze-dried pineapple; and
3.28 wt %-4.01 wt % powder of freeze-dried apple.
